(19) United States
(12) Patent Application Publication
(10) Pub. No.: US 2018/0317040 A1
(43) Pub. Date: Nov. 1, 2018

(54) MASSIVE SMALL DATA TRANSMISSION FOR MACHINE-TYPE COMMUNICATION SYSTEM

(71) Applicant: Institute For Information Industry, Taipei (TW)

(72) Inventor: Wen-Kang CHIA, New Taipei City (TW)

(21) Appl. No.: 15/497,830

(22) Filed: Apr. 26, 2017

(51) Int. Cl. H04W 4/00; H04W 72/04; H04L 5/00; H04W 24/08

(52) U.S. Cl. CPC H04W 4/005; H04W 72/04; H04W 88/02; H04W 24/08; H04L 5/0007

(57) ABSTRACT

A machine-type communication system and a massive small data transmission method thereof are provided. The machine-type communication system includes a base station and a plurality of mobile apparatuses. Each mobile apparatus has its own unique private vector data provided by the base station. The plurality of mobile apparatuses includes a first mobile apparatus with first private vector data. The base station receives a plurality of small data corresponding to the plurality of mobile apparatuses from a backhaul network server, and calculates scalar data, which corresponds to the plurality of small data, according to the plurality of small data and the plurality of private vector data. The base station transmits the scalar data to each of the plurality of mobile apparatuses using broadcast or multicast manner. The first mobile apparatus retrieves first small data from the scalar data according to the first private vector data. The first small data corresponds to the first mobile apparatus.

### FIELD

The present invention relates to a machine-type communication system and a massive small data transmission method thereof; and more particularly, the machine-type communication system and the massive small data transmission method thereof of the present invention complete data transmission by integrating small data.

### BACKGROUND

In the Machine-Type Communication (MTC) technology of the known Long Term Evolution (LTE) system, a downlink data transmission architecture takes the orthogonal frequency-division multiplexing (OFDM) as the major modulation mechanism, and the minimum downlink data transmission unit is defined as a resource block (RB).

Further speaking, each RB consists of a fixed number of subcarriers and time slots, and may be adapted for use in different modulation, encoding and power transmission applications depending on conditions of the communication apparatus/communication terminal, which represents great conveniences.

However, the data size that can be carried by each RB is fixed (about 4 Bytes to 16 Bytes). Accordingly, when the downlink data transmission type is massive small data transmission, because mostly the data volume of single small data is smaller than the fixed data capacity that can be carried by a single RB, padding of resources will be generated in the single RB when the single RB is used to carry and transmit the single small data. This leads to poor resource utilization efficiency when the downlink data is massive small data.

Moreover, when the base station is to transmit different small data to different mobile apparatuses, the transmission sequence of the plurality of small data is scheduled in advance. Therefore, because small data scheduled later will result in a transmission delay, excessive small data transmission will result in an unduly long data transmission delay of the small data scheduled later in addition to the aforesaid poor resource utilization efficiency when there are a large number of mobile apparatuses in the network.

Accordingly, a common effort shall be made in the art to improve the machine-type communication system so as to significantly improve the efficiency of radio resources, reduce the transmission delay of massive small data and lower the load of the communication system.

### SUMMARY

An objective of is to provide a machine-type communication system for massive small data transmission, which comprises a base station and a plurality of mobile apparatuses. Each of the mobile apparatuses has its own unique private vector data provided by the base station. The mobile apparatuses can include a first mobile apparatus having first private vector data. The base station can receive a plurality of small data corresponding to the mobile apparatuses from a backhaul network server, and calculates scalar data corresponding to the plurality of small data according to the plurality of small data and the private vector data of the mobile apparatuses. Then the base station transmits the scalar data to the mobile apparatuses. The first mobile apparatus retrieves first small data corresponding to the first mobile apparatus from the scalar data according to the first private vector data.

The disclosure also includes a massive small data transmission method for use in a machine-type communication system is further disclosed. The machine-type communication system comprises a base station and a plurality of mobile apparatuses. Each of the mobile apparatuses has its own unique private vector data provided by the base station. The mobile apparatuses include a first mobile apparatus having first private vector data. The massive small data transmission method comprises: (a) enabling the base station to receive small data corresponding to the mobile apparatuses from a backhaul network server; (b) enabling the base station to calculate scalar data corresponding to the small data according to the small data and the private vector data of the mobile apparatuses; (c) enabling the base station to transmit the scalar data to the mobile apparatuses; (d) enabling the first mobile apparatus to retrieve first small data corresponding to the first mobile apparatus from the scalar data according to the first private vector data.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is schematic view of a machine-type communication system according to a first embodiment of the present invention;

FIG. 1B is a block diagram of a base station according to the first embodiment of the present invention;

FIG. 1C is a block diagram of a mobile apparatus according to the first embodiment of the present invention;

FIG. 1D is a schematic view illustrating operations of the machine-type communication system according to the first embodiment of the present invention;

FIG. 2A is a schematic view of the machine-type communication system according to a second embodiment of the present invention;

FIG. 2B is a schematic view illustrating operations of the machine-type communication system according to the second embodiment of the present invention;

FIG. 3 is a schematic view illustrating operations of the machine-type communication system according to a third embodiment of the present invention;

FIG. 4 is a flowchart diagram of a massive small data transmission method according to a fourth embodiment of the present invention;

FIG. 5 is a flowchart diagram of a massive small data transmission method according to a fifth embodiment of the present invention; and

FIG. 6 is a flowchart diagram of a massive small data transmission method according to a sixth embodiment of the present invention.

### DETAILED DESCRIPTION

In the following description, the present invention will be explained with reference to certain example embodiments thereof. It shall be appreciated that these example embodiments are not intended to limit the present invention to any specific environment, embodiment, example, applications or particular implementations described in these example embodiments. Therefore, description of these example embodiments is only for purpose of illustration rather than to limit the present invention, and the scope of this application shall be governed by the claims.

In the following embodiments and the attached drawings, elements unrelated to the present invention are omitted from depiction; and dimensional relationships among individual elements in the attached drawings are illustrated only for ease of understanding, but not to limit the actual scale.

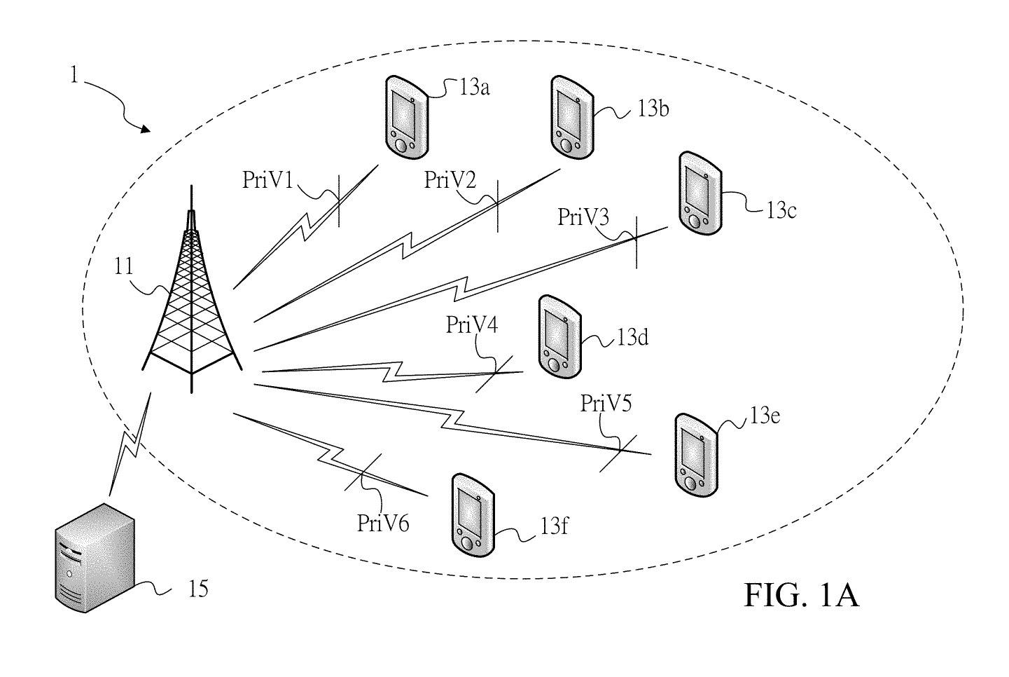

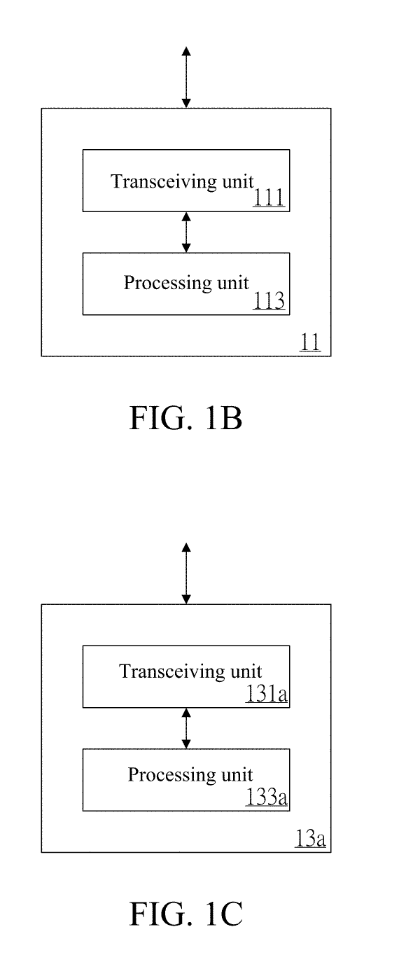

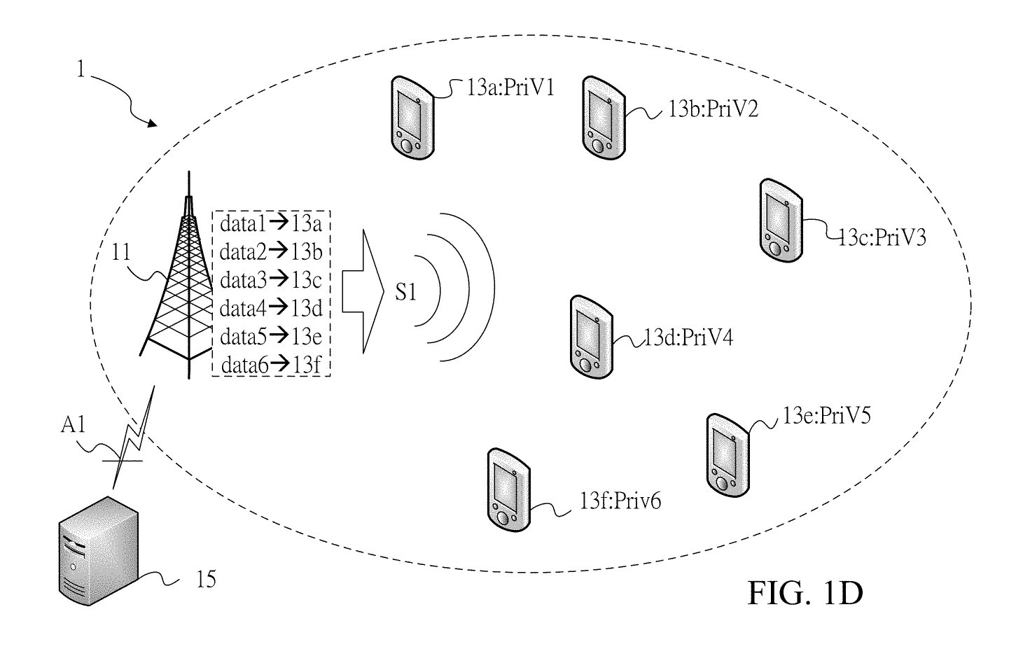

Please refer to FIG. 1A to FIG. 1C. FIG. 1A is a schematic view of a machine-type communication system 1 according to a first embodiment of the present invention. The machine-type communication system 1 comprises a base station 11 and a plurality of mobile apparatuses 13a to 13f. There is a data transmission connection between the base station 11 and a backhaul network server 15. FIG. 1B is a block diagram of the base station 11 according to the first embodiment of the present invention. FIG. 1C is a block diagram of the mobile apparatus 13a according to the first embodiment of the present invention. The mobile apparatuses 13b to 13f are identical to the mobile apparatus 13a in terms of their architectures and functions, and thus will not be further described herein.

Additionally, after the mobile apparatuses 13a to 13f have registered with the base station 11, the base station 11 firstly provides private vector data PriV1 to PriV6 to the mobile apparatuses 13a to 13f respectively for use in verification of data subsequently received. Each of the private vector data PriV1 to PriV6 is unique. Interactions between elements will be further described hereinafter.

Please refer to FIG. 1D together, which is a schematic view illustrating operations of the machine-type communication system 1 according to the first embodiment of the present invention. Firstly, a processing unit 113 of the base station 11 receives data A1 from the backhaul network server 15 via a transceiving unit 111, where the data A1 comprises a plurality of small data data1 to data6 corresponding to the mobile apparatuses 13a to 13f. Then, the processing unit 113 of the base station 11 calculates scalar data S1 corresponding to the plurality of small data data1 to data6 according to the plurality of small data data1 to data6 and the private vector data PriV1 to PriV6 of the mobile apparatuses 13a to 13f.

Subsequently, the transceiving unit 111 of the base station 11 transmits (e.g., broadcasts or multicasts) the scalar data S1 to the mobile apparatuses 13a to 13f simultaneously by use of resource blocks (RB). On the other hand, upon receiving the scalar data S1, the mobile apparatuses 13a to 13f may retrieve the corresponding small data data1 to data6 from the scalar data S1 respectively according to their own private vector data PriV1 to PriV6.

In more detail and taking the mobile apparatus 13a as an example, when the scalar data S1 is received from the base station 11 by the transceiving unit 131a of the mobile apparatus 13a, the mobile apparatus 13a can retrieve the small data data1 from the scalar data S1 directly according to the private vector data PriV1 because the small data data1 to be transmitted to the mobile apparatus 13a and the corresponding private vector data PriV1 are used in the calculation of the scalar data S1. Thus, the small data data1 to be transmitted by the base station 11 to the mobile apparatus 13a can be obtained by the mobile apparatus 13a.

It shall be particularly appreciated that, because of the uniqueness of the private vector data used in the present invention, each of the mobile apparatuses can only retrieve small data corresponding to its private vector data from the scalar data. For example, because the mobile apparatus 13a only has the private vector data PriV1, the mobile apparatus 13a can only retrieve the small data data1, rather than other small data, from the scalar data S1 according to the private vector data PriV1.

It shall also be particularly emphasized that, although six mobile apparatuses are described in the first embodiment, this is not intended to limit the number of the mobile apparatuses. Besides, the small data data1 to data6 corresponding to the mobile apparatuses 13a to 13f are decided by the backhaul network server 15 (e.g., a core network) and are then received by the base station 11 to calculate the scalar data S1 according to the small data data1 to data6, and the scalar data S1 is forwarded to the corresponding mobile apparatuses 13a to 13f.

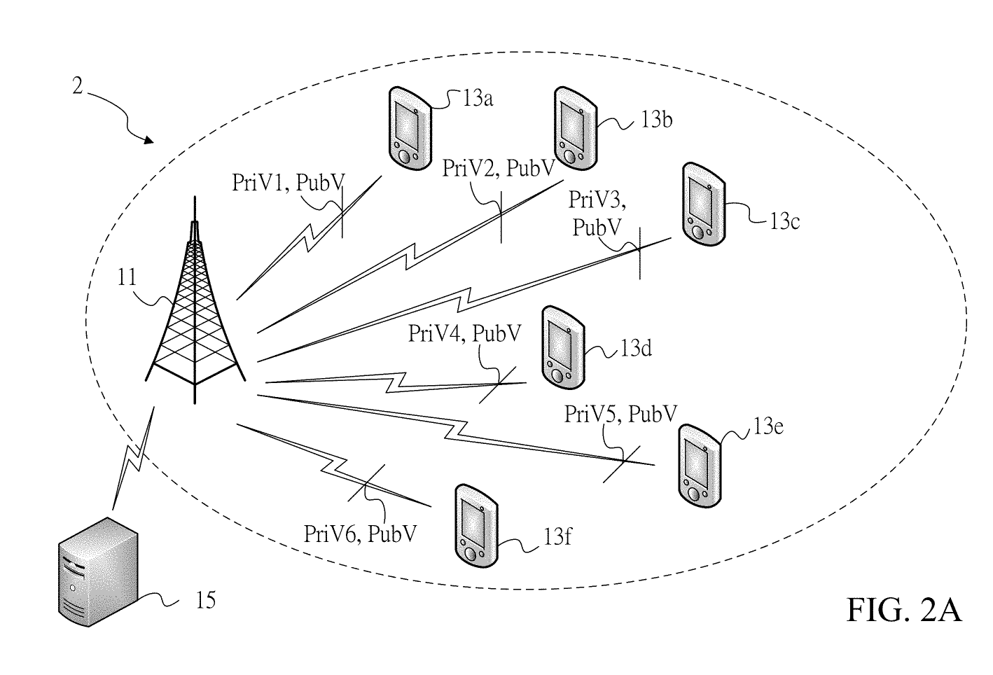

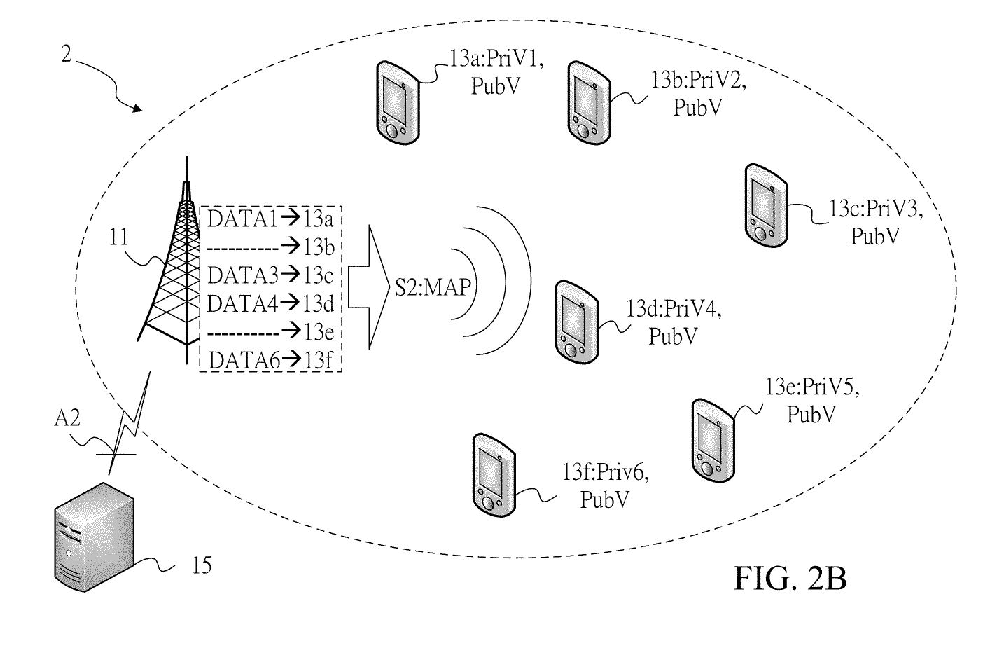

Please refer to FIG. 2A to FIG. 2B. FIG. 2A is a schematic view of a machine-type communication system 2 according to a second embodiment of the present invention, and FIG. 2B is a schematic view illustrating operations of the machine-type communication system 2 according to the second embodiment of the present invention. The second embodiment is similar to the first embodiment in network architecture, so elements bearing the same reference symbols have also the same functions and, thus, will not be further described herein. The second embodiment is mainly to further detail another implementation of massive small data transmission.

In particular, in the second embodiment, the base station 11 not only provides the private vector data PriV1 to PriV6 as described in the first embodiment, but also provides public vector data PubV to the mobile apparatuses 13a to 13f. In other words, each of the mobile apparatuses 13a to 13f has also the commonly used public vector data PubV in addition to its own private vector data PriV1 to PriV6.

Firstly, unlike the first embodiment, the processing unit 113 of the base station 11 receives data A2 from the backhaul network server 15 via the transceiving unit 111 in the second embodiment, where the data A2 comprises a plurality of small data DATA1, DATA3, DATA4 and DATA6 corresponding to the mobile apparatuses 13a, 13c, 13d and 13f. In other words, the data A2 has only small data that needs to be transmitted to the mobile apparatuses 13a, 13c, 13d and 13f, but no small data to be transmitted to the mobile apparatuses 13b and 13e.

Meanwhile, the processing unit 113 of the base station 11 decides correspondence relationship vector data MAP1 between the plurality of small data DATA1, DATA3, DATA4 and DATA6 and the mobile apparatuses 13a to 13f. The correspondence relationship vector data MAP1 records a correspondence relationship between the plurality of small data and the mobile apparatuses 13a to 13f for each of the mobile apparatuses to preliminarily determine if there is any small data transmitted from the apparatus itself.

In more detail, the processing unit 113 of the base station 11 calculates scalar data S2 corresponding to the small data DATA1, DATA3, DATA4 and DATA6 according to the small data DATA1, DATA3, DATA4 and DATA6, the corresponding private vector data PriV1, PriV3, PriV4 and PriV6, the public vector data PubV and the correspondence relationship vector data MAP1.

Then, the transceiving unit 111 of the base station 11 transmits the scalar data S2 to the mobile apparatuses 13a to 13f simultaneously by use of resource blocks. On the other hand, upon receiving the scalar data S2, each of the mobile apparatuses 13a to 13f firstly determines whether there is any data transmitted to the apparatus itself according to the public vector data PubV, and then determines whether it is necessary to retrieve small data corresponding to the mobile apparatus from the scalar data S2 accordingly.

In detail, taking the mobile apparatus 13a as an example, the mobile apparatus 13a having received the scalar data S2 firstly retrieves the correspondence relationship vector data MAP1 from the scalar data S2 according to the public vector data PubV. Because the correspondence relationship vector data MAP1 records the small data DATA1 corresponding to the mobile apparatus 13a, the mobile apparatus 13a can then determine that the scalar data S2 comprises the small data DATA1 corresponding to the mobile apparatus 13a, and further retrieve the small data DATA1 from the scalar data S2 according to the corresponding private vector data PriV1.

On the other hand, taking the mobile apparatus 13b as an example, the mobile apparatus 13b having received the scalar data S2 firstly retrieves the correspondence relationship vector data MAP1 from the scalar data S2 according to the public vector data PubV. Because there is no small data to be transmitted to the mobile apparatus 13b according to the records of the correspondence relationship vector data MAP1, the mobile apparatus 13b may subsequently discard the scalar data S2.

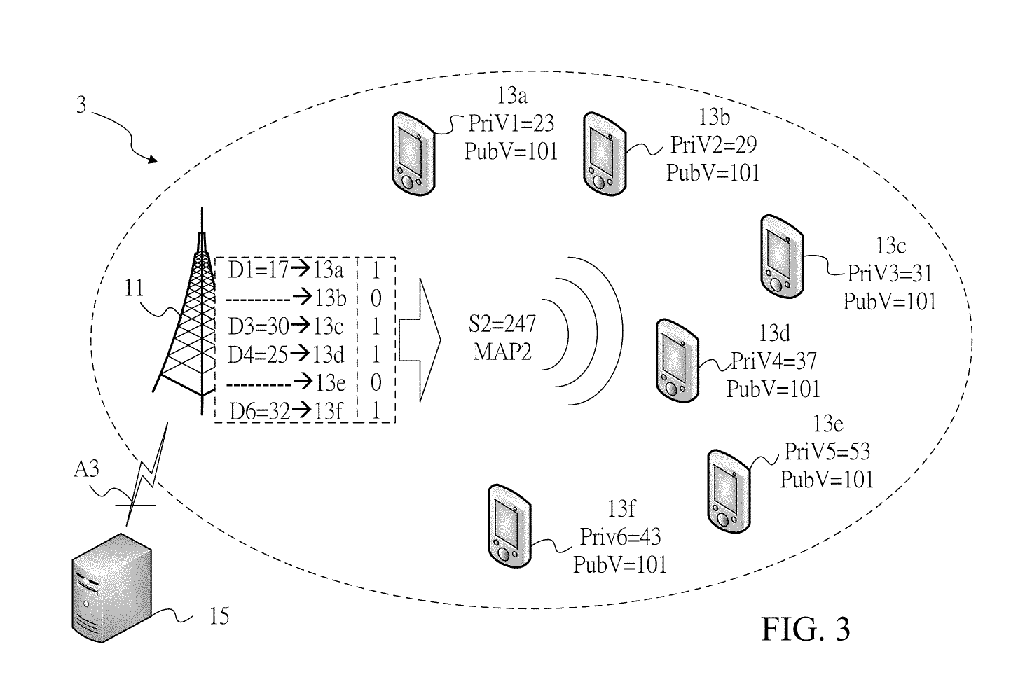

Please refer to FIG. 3, which is a schematic view illustrating operations of a machine-type communication system 3 according to a third embodiment of the present invention. The third embodiment is similar to the aforesaid embodiments in network architecture, so elements bearing the same reference symbols have also the same functions and, thus, will not be further described herein. The third embodiment is mainly to further illustrate detailed operation rules for data transmission of the present invention by means of the Chinese Remainder Theorem.

In the third embodiment, the public vector data PubV and the private vector data PriV1 to PriV6 of the machine-type communication system 3 are unique prime numbers, where PubV is 101 and PriV1 to PriV6 are respectively 23, 29, 31, 37, 53 and 43. In the third embodiment, the processing unit 113 of the base station 11 receives data A3 from the backhaul network server 15 via the transceiving unit 111, where the data A3 comprises a plurality of small data D1, D3, D4 and D6, whose values are respectively 17, 30, 25 and 32, corresponding to the mobile apparatuses 13a, 13c, 13d and 13f. Likewise, there is only small data that needs to be transmitted to the mobile apparatuses 13a, 13c, 13d and 13f, but no small data to be transmitted to the mobile apparatuses 13b and 13e.

Then, the processing unit 113 of the base station 11 decides correspondence relationship vector data MAP2 between the plurality of small data D1, D3, D4 and D6 and the mobile apparatuses 13a to 13f. In the third embodiment, the correspondence relationship vector data MAP2 records a correspondence relationship between the plurality of small data and the mobile apparatuses 13a to 13f by use of the serial numbers of the apparatuses.

Further speaking, in the third embodiment, the mobile apparatuses 13a to 13f have serial numbers of 1 to 6, so the correspondence relationship vector data MAP2 may use a six-bit binary value to sequentially record whether there is small data that needs to be transmitted to the mobile apparatuses 13a to 13f having the serial numbers of 1 to 6 (with 1 representing that there is data to be transmitted and 0 representing that there is no data to be transmitted).

In this implementation, the relationship of the small data transmitted by the base station 11 to the mobile apparatuses 13a to 13f is: (1) the mobile apparatus 13a has small data D1 and is denoted by a binary value 1; (2) the mobile apparatus 13b has no small data and is denoted by a binary value 0; (3) the mobile apparatus 13c has small data D3 and is denoted by the binary value 1; (4) the mobile apparatus 13d has small data D4 and is denoted by the binary value 1; (5) the mobile apparatus 13e has no small data and is denoted by the binary value 0; (6) the mobile apparatus 13f has small data D6 and is denoted by the binary value 1, so the correspondence relationship vector data MAP2 is a six-bit binary value 101101 (i.e., 45 in the decimal system).

Subsequently, the base station 11 utilizes the Chinese Remainder Theorem to calculate the scalar data S2 according to the plurality of small data D1, D3, D4 and D6, the private vector data PriV1, PriV3, PriV4 and PriV6 of the mobile apparatuses 13a, 13c, 13d and 13f, the public vector data PubV and the correspondence relationship vector data MAP2, with the private vector data PriV1, PriV3, PriV4 and PriV6 and the public vector data PubV representing a divisor, the correspondence relationship vector data MAP2 and the plurality of small data D1, D3, D4 and D6 representing a remainder and the scalar data S2 representing a dividend.

In other words, the scalar data S2 needs to meet the following conditions:

S2% PubV=MAP2 (i.e., S2% 101=45)

S2% PriV1=D1 (i.e., S2% 23=17)

S2% PriV3=D3 (i.e., S2%31=30)

S2% PriV4=D4 (i.e., S2%37=25)

S2% PriV6=D6 (i.e., S2% 43=32)

Accordingly, the base station 11 can calculate the scalar data S2=247 according to the Chinese Remainder Theorem, and transmit the scalar data S2 to the mobile apparatuses 13a to 13f through broadcasting or multicasting accordingly.

Then, taking the mobile apparatus 13a as an example, the mobile apparatus 13a firstly retrieves the correspondence vector data MAP2 from the scalar data S2 according to the public vector data PubV and determines whether there is small data needed by the mobile apparatus 13a itself accordingly. In detail, the mobile apparatus 13a divides the scalar data S2 (i.e., 247) by PubV (i.e., 101), with a remainder obtained being the correspondence relationship vector data MAP2 (i.e., 45), and further converts 45 into a binary value 101101.

In this case, because the mobile apparatus 13a determines that a first binary bit corresponding to the correspondence relationship vector data MAP2 is 1 (representing that there is corresponding data to be transmitted), the mobile apparatus 13a can determine that the scalar data S2 comprises small data to be transmitted to the mobile apparatus 13a itself. Accordingly, the mobile apparatus 13a retrieves the small data D1 from the scalar data S2 according to the private vector data PriV1. In detail, the mobile apparatus 13a divides the scalar data S2 (i.e., 247) by PriV1 (i.e., 23), with a remainder obtained being the small data D1 (i.e., 17).

Similarly, the mobile apparatuses 13c, 13d and 13f can determine that the scalar data S2 includes the small data to be transmitted to the respective mobile apparatuses themselves respectively in the same manner, and further retrieve the small data D3, D4 and D6 corresponding to the mobile apparatuses from the scalar data S2.

On the other hand, taking the mobile apparatus 13b as an example, the mobile apparatus 13b also retrieves the correspondence relationship vector data MAP2 from the scalar data S2 according to the public vector data PubV, and determines whether there is small data that is needed by the mobile apparatus 13b itself accordingly. In detail, the mobile apparatus 13b divides the scalar data S2 (i.e., 247) by PubV (i.e., 101), with a remainder being the correspondence relationship vector data MAP2 (i.e., 45). The mobile apparatus 13b further converts 45 into the binary digit 101101.

In this case, because the mobile apparatus 13b determines that a second binary bit corresponding to the correspondence relationship vector data MAP2 is 0 (representing that there is no corresponding data to be transmitted), the mobile apparatus 13b can determine that the scalar data S2 comprises no small data to be transmitted to the mobile apparatus 13b itself and directly discard the scalar data S2. Likewise, the mobile apparatus 13e can determine that the scalar data S2 comprises no small data to be transmitted to the mobile apparatus 13e itself and discard the scalar data S2 accordingly in the same manner.

It shall be particularly emphasized that, because the Chinese Remainder Theorem is used, the public vector data and the private vector data are unique prime numbers in the third embodiment. Taking the relationship between the divisor (the vector) and the remainder (the small data) into consideration, the public vector data must be set to a value greater than values possibly used for the correspondence relationship vector data and the private vector data must be set to a value greater than values of corresponding small data possibly generated so as to meet the relationship between the divisor and the remainder in the Chinese Remainder Theorem.

Additionally, although the aforesaid remainder of the Chinese Remainder Theorem is a decimal positive integer, the data transmission form of the small data in the present invention is not limited to the decimal positive integer. In other words, the small data of the present invention can be converted into different data forms (e.g., binary, octal or hexadecimal data) before being transmitted, and then be converted back into a decimal positive integer in a corresponding conversion manner.

Moreover, in the aforesaid third embodiment, use of the Chinese Remainder Theorem is mainly intended to illustrate operations of the present invention, but not to limit the implementation of the present invention; and other calculation methods that can also achieve the technical effects of the present invention may be readily appreciated by those skilled in the art from the above disclosures and, thus, will not be further described herein.

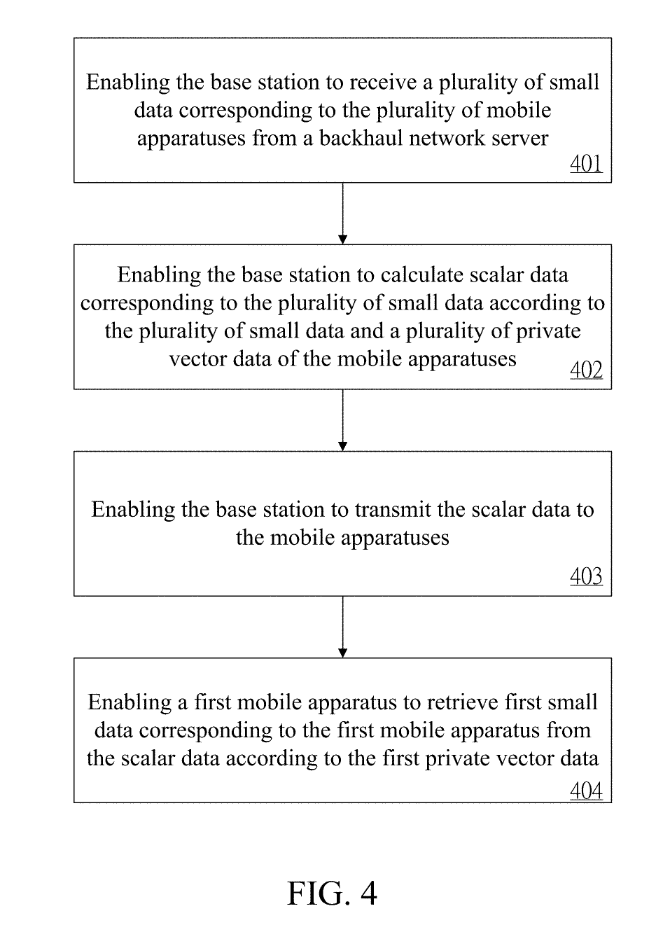

A fourth embodiment of the present invention is a massive small data transmission method, a flowchart diagram of which is shown in FIG. 4. The method of the fourth embodiment is for use in a machine-type communication system (e.g., any of the machine-type communication systems of the aforesaid embodiments). The machine-type communication system comprises a base station and a plurality of mobile apparatuses, and there is a data transmission connection between the base station and a backhaul network server. Each of the mobile apparatuses has its own unique private vector data provided by the base station, and the mobile apparatuses include a first mobile apparatus having first private vector data. Detailed steps of the fourth embodiment are described as follows.

Firstly, step 401 is executed to enable the base station to receive a plurality of small data corresponding to the plurality of mobile apparatuses from the backhaul network server. Step 402 is executed to enable the base station to calculate scalar data corresponding to the plurality of small data according to the plurality of small data and the plurality of private vector data of the mobile apparatuses. Step 403 is executed to enable the base station to transmit the scalar data to the mobile apparatuses. Step 404 is executed to enable the first mobile apparatus to retrieve first small data corresponding to the first mobile apparatus from the scalar data according to the first private vector data.

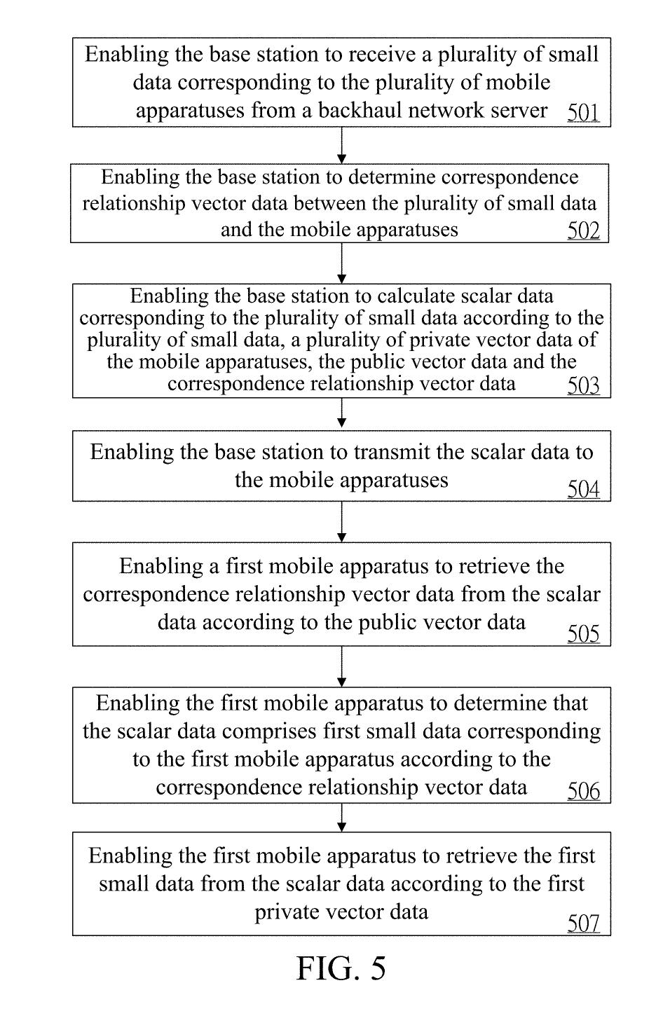

A fifth embodiment of the present invention is a massive small data transmission method, a flowchart diagram of which is shown in FIG. 5. The method of the fifth embodiment is for use in a machine-type communication system (e.g., any of the machine-type communication systems of the aforesaid embodiments). The machine-type communication system comprises a base station and a plurality of mobile apparatuses, and there is a data transmission connection between the base station and a backhaul network server. Each of the mobile apparatuses has its own unique private vector data provided by the base station, each of the mobile apparatuses further has public vector data provided by the base station, and the mobile apparatuses include a first mobile apparatus having first private vector data. Detailed steps of the fifth embodiment are described as follows.

Firstly, step 501 is executed to enable the base station to receive a plurality of small data corresponding to the plurality of mobile apparatuses from the backhaul network server. Step 502 is executed to enable the base station to determine correspondence relationship vector data between the plurality of small data and the mobile apparatuses. Step 503 is executed to enable the base station to calculate scalar data corresponding to the plurality of small data according to the plurality of small data, a plurality of private vector data of the mobile apparatuses, the public vector data and the correspondence relationship vector data. Step 504 is executed to enable the base station to transmit the scalar data to the mobile apparatuses.

Step 505 is executed to enable the first mobile apparatus to retrieve the correspondence relationship vector data from the scalar data according to the public vector data. Step 506 is executed to enable the first mobile apparatus to determine that the scalar data comprises first small data corresponding to the first mobile apparatus according to the correspondence relationship vector data. Step 507 is executed to enable the first mobile apparatus to retrieve the first small data from the scalar data according to the first private vector data.

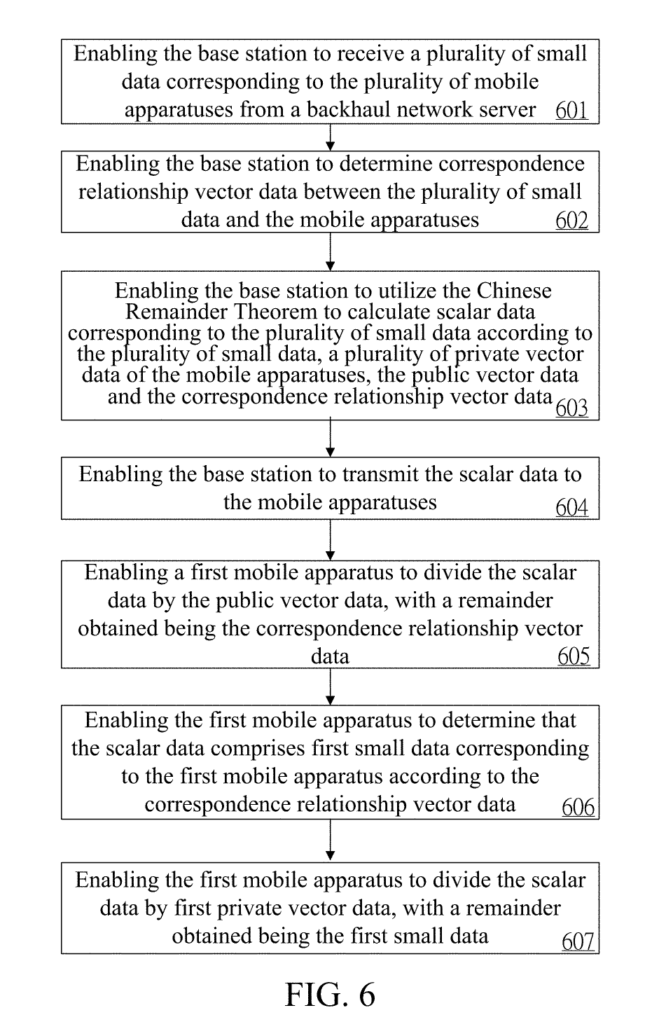

A sixth embodiment of the present invention is a massive small data transmission method, a flowchart diagram of which is shown in FIG. 6. The method of the sixth embodiment is for use in a machine-type communication system (e.g., any of the machine-type communication systems of the aforesaid embodiments). The machine-type communication system comprises a base station and a plurality of mobile apparatuses, and there is a data transmission connection between the base station and a backhaul network server. Each of the mobile apparatuses has its own unique private vector data provided by the base station, each of the mobile apparatuses further comprises public vector data provided by the base station, and the mobile apparatuses include a first mobile apparatus having first private vector data. Detailed steps of the sixth embodiment are described as follows.

Firstly, step 601 is executed to enable the base station to receive a plurality of small data corresponding to the plurality of mobile apparatuses from the backhaul network server. Step 602 is executed to enable the base station to determine correspondence relationship vector data between the plurality of small data and the mobile apparatuses. Step 603 is executed to enable the base station to utilize the Chinese Remainder Theorem to calculate scalar data corresponding to the plurality of small data according to the plurality of small data, the plurality of private vector data of the mobile apparatuses, the public vector data and the correspondence relationship vector data, with the plurality of private vector data and the public vector data representing a divisor, the correspondence relationship vector data and the plurality of small data representing a remainder and the scalar data representing a dividend.

Step 604 is executed to enable the base station to transmit the scalar data to the mobile apparatuses. Step 605 is executed to enable the first mobile apparatus to divide the scalar data by the public vector data, with a remainder obtained by dividing the scalar data by the public vector data being the correspondence relationship vector data. Step 606 is executed to enable the first mobile apparatus to determine that the scalar data comprises first small data corresponding to the first mobile apparatus according to the correspondence relationship vector data. Step 607 is executed to enable the first mobile apparatus to divide the scalar data by first private vector data, with a remainder obtained by dividing the scalar data by the first private vector data being the first small data.

In summary, the base station of the present invention mainly calculates scalar data from small data through private vector data in an integrated way, so as the total amount of small data increases, the amount of scalar data will increase and the utilization efficiency of the resource blocks will be improved greatly. Moreover, because the scalar data is transmitted to a plurality of mobile apparatuses simultaneously through multicasting or broadcasting, no data transmission delay will be caused. Additionally, the present invention further uses the public vector data and the correspondence relationship to accelerate the determination by the mobile apparatuses of whether the scalar data comprises small data that is needed by the respective mobile apparatuses themselves, thus further improving the efficiency of data processing.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A machine-type communication system for massive small data transmission, comprising:
a base station;
a plurality of mobile apparatuses, each of the mobile apparatuses having its own unique private vector data provided by the base station, the mobile apparatuses including a first mobile apparatus having first private vector data;
wherein the base station receives a plurality of small data corresponding to the mobile apparatuses from a backhaul network server, calculates scalar data corresponding to the plurality of small data according to the plurality of small data and the private vector data of the mobile apparatuses, and transmits the scalar data to the mobile apparatuses, and the first mobile apparatus retrieves first small data corresponding to the first mobile apparatus from the scalar data according to the first private vector data.

2. The machine-type communication system of claim 1, wherein each of the mobile apparatuses further has public vector data provided by the base station, the base station further decides correspondence relationship vector data between the plurality of small data and the mobile apparatuses, calculates the scalar data corresponding to the plurality of small data according to the plurality of small data, the private vector data of the mobile apparatuses, the public vector data and the correspondence relationship vector data, and the first mobile apparatus further retrieves the correspondence relationship vector data from the scalar data according to the public vector data, determines that the scalar data comprises the first small data corresponding to the first mobile apparatus according to the correspondence relationship vector data, and retrieves the first small data from the scalar data according to the first private vector data.

3. The machine-type communication system of claim 2, wherein the public vector data and the private vector data are unique prime number data, the base station further utilizes the Chinese Remainder Theorem to calculate the scalar data corresponding to the plurality of small data according to the plurality of small data, the private vector data of the mobile apparatuses, the public vector data and the correspondence relationship vector data, with the private vector data and the public vector data representing a divisor, the correspondence relationship vector data and the plurality of small data representing a remainder and the scalar data representing a dividend, and the first mobile apparatus further divides the scalar data by the public vector data and further divides the scalar data by the first private vector data, with a remainder obtained by dividing the scalar data by the public vector data being the correspondence relationship vector data and a remainder obtained by dividing the scalar data by the first private vector data being the first small data.

4. The machine-type communication system of claim 1, wherein the base station further broadcasts or multicasts the scalar data to the mobile apparatuses.

5. A base station for use in a machine-type communication system, the machine-type communication system being used for massive small data transmission and further comprising a plurality of mobile apparatuses, each of the mobile apparatuses having its own unique private vector data provided by the base station, the base station comprising:
a transceiver and
a processor;
wherein the processor receives a plurality of small data corresponding to the mobile apparatuses from a backhaul network server, calculates scalar data corresponding to the plurality of small data according to the plurality of small data and the private vector data of the mobile apparatuses, and transmits the scalar data to the mobile apparatuses via the transceiver so that each of the mobile apparatuses retrieves one of the small data that corresponds to the mobile apparatus from the scalar data according to the private vector data.

6. The base station of claim 5, wherein each of the mobile apparatuses further has public vector data provided by the base station, the processor further decides correspondence relationship vector data between the plurality of small data and the mobile apparatuses, and calculates the scalar data corresponding to the plurality of small data according to the plurality of small data, the private vector data of the mobile apparatuses, the public vector data and the correspondence relationship vector data.

7. The base station of claim 6, wherein the public vector data and the private vector data are unique prime number data, and the processor further utilizes the Chinese Remainder Theorem to calculate the scalar data corresponding to the plurality of small data according to the private vector data of the mobile apparatuses, the public vector data and the correspondence relationship vector data, with the private vector data and the public vector data representing a divisor, the correspondence relationship vector data and the plurality of small data representing a remainder and the scalar data representing a dividend.

8. The base station of claim 5, wherein the base station further broadcasts or multicasts the scalar data to the mobile apparatuses.

9. A first mobile apparatus for use in a machine-type communication system, the machine-type communication system further comprising a base station, and the first mobile apparatus having unique first private vector data provided by the base station, the first mobile apparatus comprising:
a transceiver; and
a processor;
wherein the first mobile apparatus receives scalar data from the base station, the scalar data being data that corresponds to a plurality of small data and that is calculated by the base station according to the first private vector data and a plurality of second private vector data, and the first mobile apparatus retrieves first small data corresponding to the first mobile apparatus from the scalar data according to the first private vector data.

10. The first mobile apparatus of claim 9, wherein the first mobile apparatus further has public vector data provided by the base station, the first mobile apparatus further retrieves correspondence relationship vector data from the scalar data according to the public vector data, the first mobile apparatus further determines that the scalar data comprises the first small data corresponding to the first mobile apparatus according to the correspondence relationship vector data, and the first mobile apparatus further retrieves the first small data from the scalar data according to the first private vector data.

11. The first mobile apparatus of claim 10, wherein the public vector data and the first private vector data are unique prime number data, and the first mobile apparatus further divides the scalar data by the public vector data and divides the scalar data by the first private vector data, with a remainder obtained by dividing the scalar data by the public vector data being the correspondence relationship vector data and a remainder obtained by dividing the scalar data by the first private vector data being the first small data.
